(19) United States
(12) Patent Application Publication
(10) Pub. No.: US 2020/0065718 A1
(43) Pub. Date: Feb. 27, 2020

(54) DYNAMIC AD-HOC AVAILABILITY AND PHYSICAL RESERVATION SYSTEM USING MARKET ANALYTICS, SOCIAL METADATA, AND COGNITIVE ANALYTICS

(71) Applicant: International Business Machines Corporation, Armonk, NY (US)

(72) Inventors: Christopher B. Moore, Vail, AZ (US); Harry R. McGregor, Tucson, AZ (US); Shaun E. Harrington, Sahuarita, AZ (US); Alec Forszt, Tucson, AZ (US); Emmanuel Barajas Gonzalez, Guadalajara (MX)

(21) Appl. No.: 16/112,527

(22) Filed: Aug. 24, 2018

(51) Int. Cl. G06Q 10/02; G06N 99/00

(52) U.S. Cl. CPC G06Q 10/02; G06N 99/005

(57) ABSTRACT

A computer-implemented method for determining ad-hoc availability of physical resources and facilitating reservation thereof is disclosed. The method includes: determining a predictive schedule of a property owner; determining, based on the predictive schedule, an availability status of one or more physical resources at a particular point in time, the one or more physical resources being owned by the property owner; and offering access to the one or more physical resources in accordance with availability status thereof. Corresponding systems and computer program product embodiments are also disclosed.

### BACKGROUND

The present invention relates to logistics, and more specifically, this invention relates to determining availability of physical resources and facilitating reservation of such physical resources based on market analytics, social metadata, and cognitive analytics.

Availability of physical resources, such as space for storing large equipment like shipping containers, vehicles, or the like, can be a fickle thing. For example, on typical days, a small suburban street may be sparsely parked most of the time, however, if a large event nearby is going on nearby, parking spaces can be downright valuable. Unfortunately, there is no existing way for a property owner to assess or assign value to physical resources short of unilateral advertising, e.g. by placing a sign near the available resources.

This approach requires the property owner to be consistently engaged and aware of any and all events that may be occurring, and when their parking locations may be available. The level of personal management required for this type of function simply isn't feasible for the average person and enormous opportunities and revenues remain out of reach for the average property owner.

Accordingly, it would be advantageous to provide systems, methods, and computer program products for dynamically determining availability of physical resources and facilitating use/consumption thereof for the mutual benefit of the property owner and a putative customer.

### SUMMARY

According to one embodiment, a computer-implemented method for determining ad-hoc availability of physical resources and facilitating reservation thereof includes: determining a predictive schedule of a property owner; determining, based on the predictive schedule, an availability status of one or more physical resources at a particular point in time, the one or more physical resources being owned by the property owner; and offering access to the one or more physical resources in accordance with availability status thereof.

According to another embodiment, a computer program product for determining ad-hoc availability of physical resources and facilitating reservation thereof includes a computer readable storage medium having program instructions embodied therewith. The program instructions are executable by a processor to cause the processor to: determine, using the processor, a predictive schedule of a property owner; determine, using the processor and based on the predictive schedule, an availability status of one or more physical resources at a particular point in time, the one or more physical resources being owned by the property owner; and offer, using the processor, access to the one or more physical resources in accordance with availability status thereof.

According to yet another embodiment, a system includes a processor; and logic integrated with the processor, executable by the processor, or integrated with and executable by the processor. The logic is configured to cause the processor, upon execution thereof, to: determine, using the processor, a predictive schedule of a property owner; determine, using the processor and based on the predictive schedule, an availability status of one or more physical resources at a particular point in time, the one or more physical resources being owned by the property owner; and offer, using the processor, access to the one or more physical resources in accordance with availability status thereof.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 is a flowchart of a method for providing a dynamic, ad-hoc availability and physical reservation system, according to one embodiment.

FIG. 4 is a flowchart of a method for determining availability, and facilitating reservations, of parking spaces, according to another embodiment of the inventive concepts presented herein.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for dynamic ad-hoc availability and physical reservation of physical resources and facilitating reservation of such physical resources based on market analytics, social metadata, and cognitive analytics.

According to one general embodiment, a computer-implemented method for determining ad-hoc availability of physical resources and facilitating reservation thereof includes: determining a predictive schedule of a property owner; determining, based on the predictive schedule, an availability status of one or more physical resources at a particular point in time, the one or more physical resources being owned by the property owner; and offering access to the one or more physical resources in accordance with availability status thereof.

According to another general embodiment, a computer program product for determining ad-hoc availability of physical resources and facilitating reservation thereof includes a computer readable storage medium having program instructions embodied therewith. The program instructions are executable by a processor to cause the processor to: determine, using the processor, a predictive schedule of a property owner; determine, using the processor and based on the predictive schedule, an availability status of one or more physical resources at a particular point in time, the one or more physical resources being owned by the property owner; and offer, using the processor, access to the one or more physical resources in accordance with availability status thereof.

According to yet another general embodiment, a system includes a processor; and logic integrated with the processor, executable by the processor, or integrated with and executable by the processor. The logic is configured to cause the processor, upon execution thereof, to: determine, using the processor, a predictive schedule of a property owner; determine, using the processor and based on the predictive schedule, an availability status of one or more physical resources at a particular point in time, the one or more physical resources being owned by the property owner; and offer, using the processor, access to the one or more physical resources in accordance with availability status thereof.

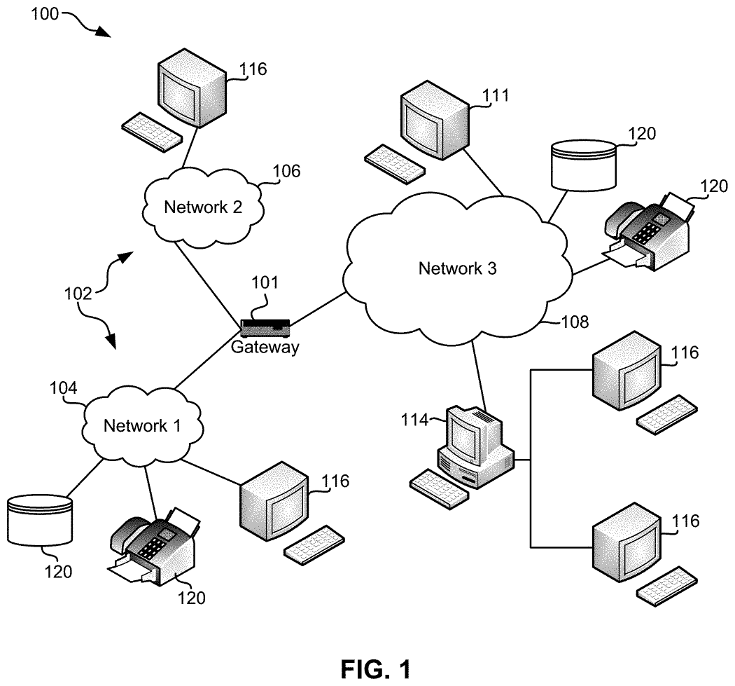

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a local area network (LAN), a wide area network (WAN) such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

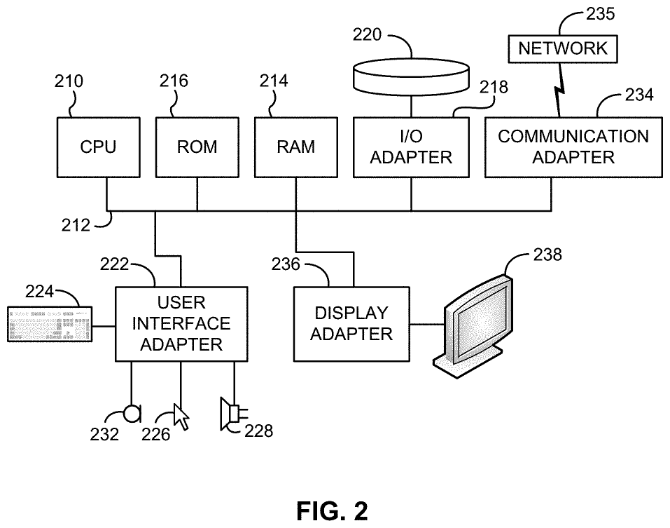

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an input/output (I/O) adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a MAC OS, a UNIX OS, etc. It will be appreciated that a preferred embodiment may also be implemented on platforms and operating systems other than those mentioned. A preferred embodiment may be written using eXtensible Markup Language (XML), C, and/or C++ language, or other programming languages, along with an object oriented programming methodology. Object oriented programming (OOP), which has become increasingly used to develop complex applications, may be used.

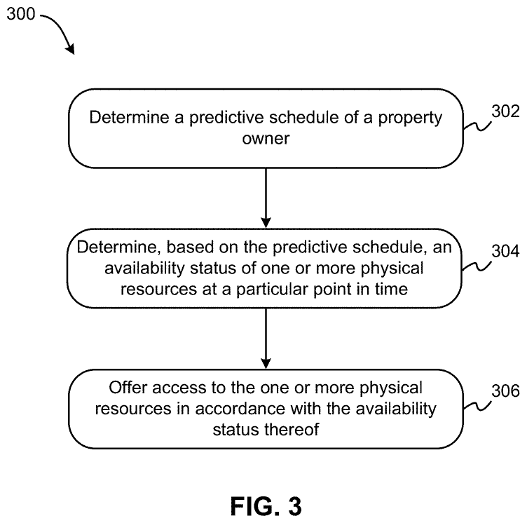

Now referring to FIG. 3, a flowchart of a method 300 is shown according to one embodiment. The method 300 may be performed in accordance with the present invention in any of the environments depicted in FIGS. 1-Y, among others, in various embodiments. Of course, more or less operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a computer, a server, combinations thereof, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3, method 300 includes operation 302, where a predictive schedule of a property owner is determined. In one embodiment, the predictive schedule is determined in whole or in part using machine learning technique(s).

In various embodiments, different machine learning techniques are utilized, singly or in combination, to determine the predictive schedule. One implementation employs a time period analysis technique. Another implementation utilizes a time series analysis technique. Still more implementations include or utilize supervised learning techniques, unsupervised learning techniques, or combinations thereof. While time period analysis and time series analysis techniques are preferred in the context of the presently described inventive concepts, those having ordinary skill in the art will appreciate other suitable techniques equivalent to those listed above, and these equivalents may be utilized singly or in combination with the particular examples listed above without departing from the scope of the present disclosure.

Moreover, according to one implementation of method 300, the predictive schedule is determined based on input collected or received from one or more sources. The sources, in different aspects of this implementation, include any combination of: the property owner, an electronic calendar of the property owner; one or more social media posts pertaining to the property owner; one or more devices providing global positioning system (GPS) location information corresponding to the property owner; one or more reservation systems managing a reservation by the property owner of a physical resource, location, and/or service; a database tracking financial activity of the property owner; a schedule of public events occurring within a given proximity of the property owner; and a municipality governing restrictions on property use, without limitation.

For example, regarding the property owner, in one approach the property owner manually inputs certain availability windows and/or excludes certain time periods for third party access to the physical resources. The property owner's work schedule, travel schedule, or any other definition of time periods when the one or more physical resources will be available to the public, or reserved for use by the property owner, may be implemented without departing from the scope of the inventive embodiments described herein, according to one aspect. For instance, the property owner may engage with a mobile or desktop application to define an initial availability of the physical resources, and this initial availability may be modified over time based on the property owner's behavior (e.g. frequency of attending events sponsored by a particular group/individual, change in work schedule, change in shopping habits, etc.)

In more embodiments, the input from the property owner may include a designation of the type of physical resource/service being offered, as well as any pertinent features/details regarding the physical resource, such as dimensions, size restrictions (e.g. number of axles, overall length, etc.), access to related services (e.g. charging stations for electric cars.)

With continuing reference to exemplary sources of input for method 300, and specifically regarding the electronic calendar of the property owner, in various embodiments, the electronic calendar may take any suitable form capable of providing/defining time windows when physical resources the property owner wishes to offer for use by the public/third parties are available. Typical examples of electronic calendars include GOOGLE calendar, iCal, Microsoft Outlook, etc., however it will be understood that in alternative embodiments the presently disclosed inventive concepts may employ other systems and/or techniques other than an electronic calendar, such as activity trackers/loggers, physical or electronic login/authentication devices/techniques, hours of operation for a business run by or employing the property owner, and any equivalents thereof, either singly or in any suitable combination, that would be appreciated by a person having ordinary skill in the art upon reading the present descriptions. In general, the electronic calendar and/or other equivalents provide information regarding the property owner's presence at a given location over time. The location in one embodiment is the property owner's home residence. In another embodiment the location is the property owner's place of work. In yet another embodiment the location is a commercial location owned or operated by the property owner. Skilled artisans will appreciate other suitable location(s) of the property owner that may be indicated by or gleaned from electronic calendars and equivalents thereof upon completing a review of the figures and descriptions detailed herein.

Now regarding social media posts pertaining to the property owner, in various aspects of the inventive concepts described herein, social media posts include any kind of post, feed, blog, link, Tweet, retweet, like, dislike, message, or other action taken by the property owner or another individual (including corporations, automated agents, etc.) on or via a social media platform, service, etc. The simplest example of a social media post pertaining to the property owner is a post, by the property owner, describing when and where the property owner will be present at a particular location, such as an announcement of a party at the property owner's residence at a particular date and time in one embodiment. Other examples will come to mind upon reading the full description of the inventive concepts described herein, and may be employed without departing from the scope of the present disclosure. For instance, in some embodiments the social media post need not be made by, or even directed specifically to, the property owner. In one instance, an individual or a group (e.g. a social association) posts an activity the property owner is likely to attend, for example, where the likelihood of attendance is determined based on the property owner being a member of the group or having expressed interests similar to those of the group posting the activity. These interests, and the likelihood of attendance, may be determined using any suitable technique understood by those having ordinary skill in the art, but preferably includes the machine learning technique(s) described elsewhere herein. At any rate, based on the posted activity, availability of physical resources such as a parking space may be determined and access to such resources offered to the public for mutual benefit.

Still referring to sources of input for method 300, in an embodiment the one or more devices providing global positioning system (GPS) location information corresponding to the property owner include the property owner's mobile phone, tablet, watch, or other mobile device/wearable; navigation systems; e.g. as may be installed in a vehicle owned/used by the property owner; or any other suitable device that would be appreciated by a person having ordinary skill in the art upon reading the present disclosure. Of course, in other embodiments, the location of the property owner may be gleaned from sources other than GPS location, including but not limited to any type of geotagging service or technique known in the art. In still more embodiments, any type of digital signature indicative of the property owner's physical location, such as social media interactions, external requests for participation in an event, etc. is a suitable source of location information to utilize in determining availability of, and/or offering access to, physical resources owned by the property owner.

Turning now to exemplary reservation systems managing a reservation by the property owner of a physical resource, location, and/or service, in one embodiment, exemplary reservation systems include a digital reservation of a table at a restaurant. In another embodiment an exemplary reservation system manages seats of a movie theatre. In still more embodiments the reservation system may manage bookings on a travel service, such as a train, a ride-sharing program, a plane, a cruise ship, etc. as will be appreciated by skilled artisans upon reading the present disclosure in full. In one approach, a reservation system manages parking availability, and may even include an ad-hoc, dynamic reservation system as described herein. In any event, the reservation systems allow inferences as to periods of time wherein the property owner is, and is not, likely to be utilizing physical resources they own, such as parking spaces, etc.

As noted above, embodiments of method 300 may utilize input from a database tracking financial activity of the property owner. For instance, in one embodiment such a database includes a shopping history of the property owner, e.g. as may be gleaned from online activity and/or financial statements of the property owner's accounts. Based on the shopping history, the likelihood of the property owner visiting a particular location, such as a favored retailer, at a particular point in time, such as a holiday sale event, may be inferred, as will be appreciated by skilled artisans having reviewed the present disclosure in its entirety. Other forms of financial tracking in accordance with one embodiment of the inventive concepts described herein include shopping lists, e.g. stored on the user's mobile device or social media profile, posted on a social media site, etc. Still further examples, in other embodiments, include digital coupons collected/stored/sent to the property owner. Of course, any suitable manner of tracking financial activity from which a property owner's likely behavior, and specifically location, at a particular point in time may be determined are capable of being employed without departing from the scope of the inventive embodiments described herein.

In several embodiments, the input used to determine the property owner's predictive schedule includes a schedule of public events occurring within a given proximity of the property owner. For example, a local professional, collegiate, or other sports team's home game schedule, which may indicate particular time periods when access to parking may be particularly desirable. In another embodiment, the schedule may include a schedule of events such as free concerts taking place at a public park or other venue. Of course, as will be appreciated by persons having ordinary skill in the art upon reading the present disclosure, the schedule may reflect any type, number, etc. of public events that are likely to impact the availability and/or desirability of physical resources (e.g. according to a supply and demand model) a property owner wishes to offer for public use.

The proximity of the property owner (or more strictly, the physical resources) and the public event may act as a filter to determine whether the property owner's physical resources are likely to increase in value in a time period leading up to and including the event. For instance, physical resources located within a certain, e.g. predetermined, radius or walking distance of a venue where the public event is taking place may be an attractive option for an attendee of the event. Meanwhile, physical resources outside the predetermined, radius or walking distance of the venue are of lesser or no interest. However, physical resources outside the predetermined radius/distance of the venue, but within a certain distance to public transportation servicing the venue, may be as attractive (or more) as physical resources within the predetermined distance. Accordingly, proximity may be determined in different embodiments by considering the raw distance (e.g. “as the bird flies”) between the physical resource and the venue; a total distance (e.g. steps taken, distance traveled) between the physical resources and the venue, optionally including one or more intermediate locations such as public transit stations, etc. as would be understood by a person having ordinary skill in the art upon reading the present descriptions.

Referring still to method 300 and determining a predictive schedule for the property owner in operation 302, in one embodiment input for determining the predictive schedule of the property owner includes the input/restrictions published by a municipality or other governing entity responsible for managing restrictions on property use, For example, the municipality may define certain times of day when particular resources are or are not eligible for use, such as a physical resource being unavailable (or available) at a particular time or to a particular type of vehicle (e.g. compact vehicles, motorcycles only, electric vehicles, zero-emission vehicles, etc.), a particular area or road being accessible by certain vehicle types only at particular times (e.g. tow-hitch vehicles/trailers only being allowed on certain roads at particular times of day, vehicles above a certain weight or number of axles being allowed on certain roads at particular times), etc. as would be understood by a person having ordinary skill in the art upon reading the present disclosure.

In one approach, based on the location of the physical resources, the application prevents rental of the resource during periods where the local municipality has restricted use thereof in certain areas, e.g. where parking or road access is restricted (e.g. during regular business hours, outside regular business hours, due to holiday restrictions, etc. as would be understood by a person having ordinary skill in the art without departing from the scope of the inventive concepts presented herein.

Of course, in addition to input pertaining to the property owner, the putative user/customer's information may additionally or alternatively be utilized to facilitate determining availability and/or offering access to physical resources. For instance, a property owner wishing to increase revenue generated by available physical resources may actively seek potential customers based on analyzing information predictive of the user/customer's location over time, and/or likely financial interests/activities that may require access to physical resources the property owner has to offer, in one embodiment.

Accordingly, in one embodiment method 300 may optionally include determining a predicted desirability of the one or more physical resources based on input collected or received from one or more sources selected from the group consisting of: one or more potential customers; an electronic calendar of the one or more potential customers; one or more social media posts pertaining to the one or more potential customers; one or more devices providing global positioning system (GPS) location information corresponding to the one or more potential customers; one or more reservation systems managing a reservation by the one or more potential customers of a physical resource, location, and/or service; a database tracking financial activity of the one or more potential customers; a schedule of public events occurring within a given proximity of the one or more physical resources; and a municipality governing restrictions on property use. In general, determining desirability of physical resources may utilize similar inputs as determining the predictive schedule according to which such resources will be available. However, determining desirability involves correlating availability with additional context, e.g. occurrence of a public event, and is thus a more complex task than simply determining availability. Determining desirability of physical resources will therefore benefit greatly from feedback and refinement of the prediction model used to predict desirability of a given resource during a given window of availability.

As shown in FIG. 3, method 300 also includes operation 304, where, based on the predictive schedule, an availability status of one or more physical resources at or over a particular point in time or time span (e.g. a given window having a defined start and end time) is determined. The availability status may be determined as a routine matter, or in response to receiving a request from a putative customer seeking access to resources of the type on offer by the property owner.

In embodiments where the availability status is determined in response to receiving a request, the request need not be received by the property owner. In preferred embodiments the customer's request is handled by a central processing system in a manner transparent to the property owner and the customer. Instead, in one embodiment by comparing the availability status of the physical resources (determined based on the property owner's predictive schedule) against the point in time or time span requested by the customer, potential reservations may be determined and automatically made, or alternatively presented to the customer and/or property owner for confirmation.

For example, in one approach when a customer initiates rental of an available parking space, their current physical location and distance from the space is calculated to determine the full amount of time for the space to be rented. If the total amount of time required for the customer to arrive at the parking space and the requested parking time exceeds the available schedule, the parking space may not be allocated to the customer, and a notification to this effect sent to the customer. The customer may then initiate a new search for a different parking space (or other physical resource as described herein) and attempt a new reservation using the same or modified parameters (e.g. location, time window, etc.).

According to one aspect of the inventive concepts presented herein, the predictive schedule and the availability of the physical resources are each determined without relying on any physical sensor tracking, reporting, or otherwise directly observing the availability of the one or more physical resources. While many conventional parking and other physical resource management systems rely on some external sensor, such as a camera, RFID reader/tags, barcode reader, etc., the presently described inventive concepts are not so reliant, and may infer or determine the availability of physical resources solely based on digital indicia of the property owner's actual or likely physical location over time, as described in greater detail above.

Regardless of the particular manner by which the predictive schedule and availability are determined, in operation 306 method 300 includes offering access to the one or more physical resources in accordance with the availability status thereof. As understood herein, offering access in accordance with availability status involves offering a customer the ability to reserve the physical resource(s) for a particular duration, e.g. during an availability window determined from the predictive schedule and availability status information. The offer does not complete the reservation, but does represent the functional endpoint of determining dynamic ad-hoc availability and physical reservations using market analytics, social metadata, and cognitive analytics, according to a preferred embodiment of the presently described inventive concepts.

To complete the reservation, the customer preferably accepts the offered access, and engages in a transfer of funds or other valuable consideration using any suitable technique that would be known by a person having ordinary skill in the art upon reading the present descriptions.

This ability to predict and offer access to physical resources without relying on sensors or other means to monitor the physical resource itself represents an improvement to reservation systems and logistics technology generally Eliminating the need to monitor sensors (and/or corresponding output) significantly reduces the time and effort required to effectively arrange and manage reservations of physical resources. Accordingly, determining a predictive schedule, determining the availability status of physical resources, and forming/managing reservations of physical resources on the basis thereof represents an improvement to the field of logistics, especially where using the predictive schedule and availability status increases overall utilization of the available physical resources in a given region, providing a corresponding economic benefit to the property owner and/or community as a whole.

The presently disclosed inventive concepts, particularly as embodied by method 300, effectively automate the management of physical resources using objective criteria and data not generally available to, or considered by, a human attempting to accomplish the same task.

In particular, by focusing on social media as a potential indication of a property owner's likely presence near, and/or need to access, a physical resource over time, analyzing such social media information using machine learning techniques such as time series analysis and/or time period analysis as objective rules, and offering access to resources based on a predicted availability thereof, a computer system enables management of physical resources without monitoring of the physical resource itself, as would be the manner typically implemented by a human to accomplish the same result.

Moreover, the volume and diversity of information taken into consideration when determining the availability/desirability of physical resources enables prediction of when and where physical resources will be in greatest demand, and is thus capable of presenting opportunities that would not otherwise be recognized by any existing analog to the presently disclosed inventive concepts. For example, a system involving conventional sensors to detect when a property owner's physical resources are in use or available is not able to predict an upcoming availability window indicated by the property owner's social media activity (e.g. a planned vacation rendering a resource typically available during regular business hours unavailable over a given period of time) or a period of increased desirability indicated by a public schedule of events, as the sensors are not privy to, and further are not designed or otherwise configured to process such information.

In one embodiment, method 300 includes registering the one or more physical resources owned by the property owner; and validating access to the one or more physical resources. Registration of the physical resources, in one approach, involves the property owner submitting a form or raw information regarding the location, size, amount, etc. of physical resources offered for public access. For instance, using parking space as an example, a property owner designates a number and/or type of spaces available for public access, and the approximate location thereof (e.g. by providing an address, GPS coordinates, geo-tagged photograph, or any other suitable form of location information as would be appreciated by a person having ordinary skill in the art upon reading the present descriptions).

Upon receiving the registered physical resource information, availability/accessibility to such resources is preferably validated. Validation, in one embodiment, involves comparing publically accessible maps or other geographic information with the information provided by the property owner during the registration process. Validation, in other embodiments, includes validating the property owner's ownership of the registered physical resource(s), such as validating a property owner owns/has rights to use a parking space located on a public street, or a particular parking space within e.g. a numbered lot.

In another embodiment, and prior to offering the customer access to the physical resources, or in response to receiving a request for access to the physical resources, the method 300 includes modifying the offered access to the one or more physical resources based on feedback from the property owner. In one embodiment, upon determining the predictive schedule, the property owner may provide feedback, e.g. confirming, negating, and/or modifying various availability windows for the various physical resources to which the property owner wishes to offer access.

For example, in one approach the property owner cancels an availability window in response to an overlapping engagement or other event requiring the property owner have access to the particular resource in question. In another approach the property owner modifies a cost of accessing a particular resource at a particular point in time, e.g. by accepting a local average pricing, or by setting a custom price upon determining a local event such as a concert is taking place during the particular point in time. In still another embodiment, the property owner creates an availability window where none previously existed in the predictive schedule, e.g. when the property owner is leaving the property for a brief period such as an hour, a day, a weekend, etc. In general, the property owner is provided the ability to dynamically control offered access to the physical resources at any point in time, as well as modifying parameters associated with access, such as cost, conditions of use (e.g. restricting a parking space to certain types of vehicles or bundling particular resources such as a parking space only being available to an individual renting the property owner's residence), duration of a previously reserved availability window, etc. as would be appreciated by a person having ordinary skill in the art upon reading the instant descriptions.

Accordingly, the presently disclosed inventive concepts, particularly as embodied in method 300, represent an improvement to computer technology and the field of physical resource management (e.g. logistics). In accordance with several preferred implementations, method 300 may include any combination of the foregoing features, operations, etc. without departing from the scope of the instant disclosure.

For instance, in one practical implementation, determining ad-hoc availability of physical resources and managing reservations thereof includes a four phase approach, involving data collection, designation and validation of resources, determining a predictive schedule of resource availability, and enabling access to the resource based on the confirmed schedule and/or pricing.

During one embodiment of data collection, calendar entries on the property owner's accessible calendars or agendas, including local smart device agenda applications as well as common cloud calendar services, are harvested, or otherwise received, e.g. by the property owner submitting such information or providing access thereto to a central server via a mobile or desktop application. Social media events that involve appointments, tickets purchased for events and other traceable pertinent data; reservations and reservation system entries or any other place with a reservation system which can be accessed to harvest pertinent usage data; digital shopping lists or “clipped” digital coupons for stores frequented by the property owner; GPS location of the property owner, in order to determine approximate physical location in relation to the designated parking spaces; and/or any digital signature which can indicate the property owners expected location and planned activities are similarly harvested or otherwise received. This may include social media interactions with other people or external requests for participation from influential people.

Designation and validation of parking spaces, in another embodiment, includes a property owner registering a set number of resources such as parking spaces for which the property owner has rights for exclusive use, and is willing to rent to customers. Available resources (again, e.g. parking spaces) are validated by comparing publically accessible maps with the reported available parking to ensure that sufficient parking is available for the number of vehicles the property owner claims can be accommodated. This prevents inadequate resource allocations (e.g. parking space(s)) to be rented to a parking customer.

Moreover, in cases where the resource is subject to restricted access, e.g. a parking space located on a public street, the property owner must provide proof of exclusive rights for that resource. The exclusive rights may be validated with an appropriate authority such as a department of commerce, agriculture, transportation, etc., in one embodiment. In another embodiment exclusive rights may be validated with an appropriate individual or entity such as a rental agency, landlord, or other superior property owner having rights to and/or managing a larger property in which the physical resources subject to reservation are located.

Determining the predictive schedule of available resources, in one approach, involves generating a predictive schedule of the property owner's activities using machine learning techniques. The predicted schedule is compared with the property owner's current location (which may be harvested from a registered smart device) to determine optimal times to propose renting of available parking spaces. The predictive schedule generates as output a per quarter hour availability map which identifies available times when the property owner is not expected to use their parking space(s). When a customer initiates rental of an available parking space, their current physical location and distance from the space is calculated to determine the full amount of time for the space to be rented. If the total amount of time required for the customer to arrive at the parking space and their requested parking time exceeds the available schedule, the parking space may not be allocated to the customer.

Enabling access to resources based on the confirmed schedule and pricing includes presenting the predictive schedule map for potential resource rental times to the property owner. The map is preferably generated based on the property owner's expected usage of the resource(s). The property owner can modify the parking schedule to correct for any unforeseen scheduling conflicts which were not detected during the data collection and analysis phase. The property owner is additionally or alternatively presented with the option of setting a custom price per time interval, or accepting an average for their area. Once the property owner accepts the completed availability schedule and pricing, the resources are placed for availability to customers. Based on the location of the resources being rented, the application prevents rental of the resource during periods where the local municipality has restricted access thereto.

Optionally, but preferably, the foregoing exemplary embodiment of dynamic ad-hoc availability and physical resource management includes modifying the predictive schedule of availability, and/or issuing penalties for customer violations. Modifications to access in some approaches include recategorizing an availability status of a physical resource previously determined to be available (or unavailable) during a given time window (e.g. removing one or more availability windows from the schedule in order to provide adequate time for the property owner to utilize the resource). Violations in various embodiments include, e.g., retaining exclusive access to the resource for a time exceeding the total amount reserved, accessing the resource outside the agreed-upon window, etc., and a property owner may issue appropriate fees in the event of such a violation.

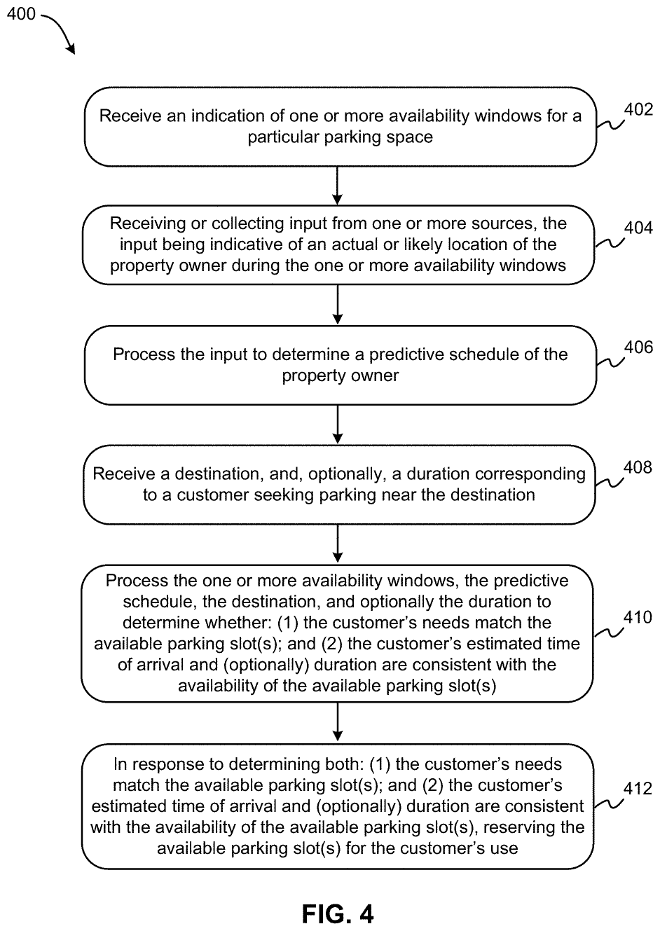

Now referring to FIG. 4, a flowchart of a specific, exemplary method 400 for determining availability of physical resources (here, parking space(s)) and facilitating access thereto is shown, according to one embodiment. The method 400 may be performed in accordance with the present invention in any of the environments depicted in FIGS. 1-2, among others, in various embodiments. Of course, more or less operations and/or features than those specifically described in FIG. 4 may be included in method 400, as would be understood by one of skill in the art upon reading the present descriptions. For example, in various implementations any combination of operations and/or features described hereinabove with reference to method 300 and FIG. 3 may be included or implemented in the context of method 400, without departing from the scope of the inventive concepts described herein.

Each of the steps of the method 400 may be performed by any suitable component of the operating environment. For example, in various embodiments, the method 400 may be partially or entirely performed by a desktop computer, server, mobile devices, some other device having one or more processors therein, and/or combinations thereof. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 includes operation 402, where a property owner specifies one or more availability windows for a particular parking space. The property owner's specified availability windows are received, e.g. at a mobile or desktop application configured to manage parking space availability. In various embodiments, the property owner may specify the availability windows using any suitable technique that would be appreciated by persons having ordinary skill in the art upon reading the present descriptions. Availability windows may be defined in any suitable manner, but in preferred approaches availability windows are defined according to a start time and an end time, and the schedule within which the availability windows are defined is delineated according to quarter-hour increments.

In operation 404 of method 400, input is collected/received from one or more sources, the input being indicative of an actual or likely location of the property owner generally, but particularly during the availability windows defined in operation 402. The sources of input and types of information, in various embodiments, include any combination of sources and information described hereinabove with reference to FIG. 3 and method 300.

Operation 406 of method 400 involves processing the input to determine a predictive schedule of the property owner. The processing in various embodiments includes machine learning techniques, such as time period analysis and/or time series analysis, in preferred approaches.

In operation 408 of method 400, a destination specified by a customer seeking parking near the specified destination is received, e.g. at the mobile or desktop application. Optionally, along with the destination, the customer may specify or estimate an amount of time or window during which the customer will occupy the parking space.

Upon receiving the customer's specified destination, and optional duration/time window, the property owner's designated availability window(s), predictive schedule, customer's destination, and optional duration/time window information are processed in operation 410 to determine whether: (1) the customer's needs (including but not limited to parking spot location and available duration) match the property owner's available parking slot(s); and (2) the customer's estimated time of arrival and duration/time window are consistent with the availability of the available parking slot(s).

In response to determining both criteria evaluated in operation 410 are met, i.e. the customer's needs are met by the available parking slot(s); and the user's required duration of occupancy of the parking slot(s) is consistent with the availability thereof, the parking slot is reserved for the customer's use in operation 412. Alternatively, if either criterion evaluated in operation 410 is not satisfied, the parking slot under evaluation is not reserved, and a next parking slot is evaluated according to operation 410 until all available parking slots have been evaluated. If no available parking slot satisfies both criteria of operation 410, then the customer is informed that no parking is currently available for the desired destination/time window, and prompted to define an alternate destination/time window within which to search for parking.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

While various embodiments have been described above, it should be understood that they have been presented by way of example only, and not limitation.

For instance, while the exemplary embodiments of the inventive concepts presented herein are described primarily with respect to availability of physical resources including essentially real estate (e.g. parking space, space for storing large equipment/containers, etc.), it should be understood that other forms of physical resources may be managed in accordance with the inventive techniques described hereinabove. For example, in one alternative embodiment the physical resource may include a vehicle owned by the property owner, in which case additional/alternative input regarding the physical resource (such as fuel levels, maintenance status/schedule, miles driven, diagnostic information from the vehicle's on-board computer, etc.) may be taken into account in determining the predictive schedule and/or availability of the physical resource. Skilled artisans reading the present descriptions will appreciate other embodiments of physical resources that may be equivalently managed, and these embodiments should be considered within the scope of the inventive concepts described herein.

Accordingly, the breadth and scope of a preferred embodiment should not be limited by any of the above-described exemplary embodiments, but should be defined only in accordance with the following claims and their equivalents.

What is claimed is:

1. A computer-implemented method for determining ad-hoc availability of physical resources and facilitating reservation thereof, the method comprising:
determining a predictive schedule of a property owner;
determining, based on the predictive schedule, an availability status of one or more physical resources at a particular point in time, the one or more physical resources being owned by the property owner; and
offering access to the one or more physical resources in accordance with availability status thereof.

2. The computer-implemented method of claim 1, wherein the predictive schedule is determined in whole or in part using at least one machine learning technique.

3. The computer-implemented method of claim 1, wherein the predictive schedule is determined based on input collected or received from one or more sources selected from the group consisting of: the property owner, an electronic calendar of the property owner, one or more social media posts pertaining to the property owner, one or more devices providing global positioning system (GPS) location information corresponding to the property owner, one or more reservation systems managing a reservation by the property owner of a physical resource, location, and/or service, a database tracking financial activity of the property owner, a schedule of public events occurring within a given proximity of the property owner, and a municipality governing restrictions on property use.

4. The computer-implemented method of claim 1, further comprising determining a predicted desirability of the one or more physical resources based on input collected or received from one or more sources selected from the group consisting of: one or more potential customers; an electronic calendar of the one or more potential customers; one or more social media posts pertaining to the one or more potential customers; one or more devices providing global positioning system (GPS) location information corresponding to the one or more potential customers; one or more reservation systems managing a reservation by the one or more potential customers of a physical resource, location, and/or service; a database tracking financial activity of the one or more potential customers; a schedule of public events occurring within a given proximity of the one or more physical resources; and a municipality governing restrictions on property use.

5. The computer-implemented method of claim 1, wherein the predictive schedule and the availability of the physical resources are each determined without relying on any physical sensor tracking, reporting, or otherwise directly observing the availability of the one or more physical resources.

6. The computer-implemented method of claim 1, further comprising modifying the offered access to the one or more physical resources based on feedback from the property owner.

7. The computer-implemented method of claim 1, further comprising:
registering the one or more physical resources owned by the property owner; and
validating access to the one or more physical resources.

8. A computer program product for determining ad-hoc availability of physical resources and facilitating reservation thereof, the computer program product comprising a computer readable storage medium having program instructions embodied therewith, the program instructions executable by a processor to cause the processor to:
determine, using the processor, a predictive schedule of a property owner;
determine, using the processor and based on the predictive schedule, an availability status of one or more physical resources at a particular point in time, the one or more physical resources being owned by the property owner; and
offer, using the processor, access to the one or more physical resources in accordance with availability status thereof.

9. The computer program product of claim 8, wherein the predictive schedule is determined in whole or in part using at least one machine learning technique.

10. The computer program product of claim 8, wherein the predictive schedule is determined based on input collected or received from one or more sources selected from the group consisting of: the property owner, an electronic calendar of the property owner, one or more social media posts pertaining to the property owner, one or more devices providing global positioning system (GPS) location information corresponding to the property owner, one or more reservation systems managing a reservation by the property owner of a physical resource, location, and/or service, a database tracking financial activity of the property owner, a schedule of public events occurring within a given proximity of the property owner, and a municipality governing restrictions on property use.

11. The computer program product of claim 8, further comprising program instructions executable by the processor to cause the processor to: determine a predicted desirability of the one or more physical resources based on input collected or received from one or more sources selected from the group consisting of: one or more potential customers; an electronic calendar of the one or more potential customers; one or more social media posts pertaining to the one or more potential customers; one or more devices providing global positioning system (GPS) location information corresponding to the one or more potential customers; one or more reservation systems managing a reservation by the one or more potential customers of a physical resource, location, and/or service; a database tracking financial activity of the one or more potential customers; a schedule of public events occurring within a given proximity of the one or more physical resources; and a municipality governing restrictions on property use.

12. The computer program product of claim 8, wherein the predictive schedule and the availability of the physical resources are each determined without relying on any physical sensor tracking, reporting, or otherwise directly observing the availability of the one or more physical resources.

13. The computer program product of claim 8, further comprising program instructions executable by the processor to cause the processor to: modify the offered access to the one or more physical resources based on feedback from the property owner.

14. The computer program product of claim 8, further comprising program instructions executable by the processor to cause the processor to:
register the one or more physical resources owned by the property owner; and
validate access to the one or more physical resources.

15. A system, comprising:
a processor; and
logic integrated with the processor, executable by the processor, or integrated with and executable by the processor, the logic being configured to cause the processor, upon execution thereof, to:
determine, using the processor, a predictive schedule of a property owner;
determine, using the processor and based on the predictive schedule, an availability status of one or more physical resources at a particular point in time, the one or more physical resources being owned by the property owner; and
offer, using the processor, access to the one or more physical resources in accordance with availability status thereof.

16. The system of claim 15, wherein the predictive schedule is determined in whole or in part using at least one machine learning technique; and
wherein the predictive schedule is determined based on input collected or received from one or more sources selected from the group consisting of: the property owner, an electronic calendar of the property owner, one or more social media posts pertaining to the property owner, one or more devices providing global positioning system (GPS) location information corresponding to the property owner, one or more reservation systems managing a reservation by the property owner of a physical resource, location, and/or service, a database tracking financial activity of the property owner, a schedule of public events occurring within a given proximity of the property owner, and a municipality governing restrictions on property use.

17. The system of claim 15, further comprising logic configured to cause the processor, upon execution thereof, to: determine a predicted desirability of the one or more physical resources based on input collected or received from one or more sources selected from the group consisting of: one or more potential customers; an electronic calendar of the one or more potential customers; one or more social media posts pertaining to the one or more potential customers; one or more devices providing global positioning system (GPS) location information corresponding to the one or more potential customers; one or more reservation systems managing a reservation by the one or more potential customers of a physical resource, location, and/or service; a database tracking financial activity of the one or more potential customers; a schedule of public events occurring within a given proximity of the one or more physical resources; and a municipality governing restrictions on property use.

18. The system of claim 15, wherein the predictive schedule and the availability of the physical resources are each determined without relying on any physical sensor tracking, reporting, or otherwise directly observing the availability of the one or more physical resources.

19. The system of claim 15, further comprising logic configured to cause the processor, upon execution thereof, to: modify the offered access to the one or more physical resources based on feedback from the property owner.

20. The system of claim 15, further comprising logic configured to cause the processor, upon execution thereof, to:
register the one or more physical resources owned by the property owner; and
validate access to the one or more physical resources.
